(19) United States
(12) Patent Application Publication
(10) Pub. No.: US 2014/0181680 A1
(43) Pub. Date: Jun. 26, 2014

(54) METHOD AND DEVICE FOR CONTACTING CONTACT PERSON

(71) Applicant: Huawei Technologies Co., Ltd., Shenzhen (CN)

(72) Inventors: Hongmin Xu, Hangzhou (CN); Tingting Zhang, Nanjing (CN); Wanling Chen, Shenzhen (CN)

(73) Assignee: Huawei Technologies Co., Ltd., Shenzhen (CN)

(21) Appl. No.: 14/100,812

(22) Filed: Dec. 9, 2013

Related U.S. Application Data
(63) Continuation of application No. PCT/CN2013/080667, filed on Aug. 1, 2013.

(30) Foreign Application Priority Data
Dec. 20, 2012 (CN) 201210555035.2

(51) Int. Cl. G06F 3/0482

(52) U.S. Cl. CPC G06F 3/0482
USPC 715/739

(57) ABSTRACT

Embodiments of the present invention relate to the network communications field and disclose a method and a device for contacting a contact person, so as to increase probability of contacting the contact person successfully at a single attempt and save user time and the operator's operation resources. The method for contacting the contact person includes: obtaining a current state of the contact person on a communications platform, where the current state indicates a state of the contact person on the communications platform at current time, and the state is determined according to an operation performed by the contact person on the communications platform or a terminal bound to the communications platform; determining a contact manner of the contact person, where the contact manner corresponds to the obtained current state; and setting the determined contact manner as a preferred contact manner of the contact person.

### CROSS-REFERENCE TO RELATED APPLICATIONS

This application is a continuation of International Application No. PCT/CN2013/080667, filed on Aug. 1, 2013, which claims priority to Chinese Patent Application No. 201210555035.2, filed on Dec. 20, 2012, both of which are hereby incorporated by reference in their entireties.

### TECHNICAL FIELD

The present invention relates to the field of network communications, and in particular, to a method and device for contacting a contact person.

### BACKGROUND

Currently, a contact person in an address book of a terminal usually has contacted in multiple manners, such as mobile phone number, office telephone number, home telephone number, and so on. Such a contact person with multiple telephone numbers may be called a multi-number contact person.

When a user wants to contact a multi-number contact person, the multi-number contact person is not necessarily contacted successfully at a single attempt, but multiple different contact manners may be attempted before the contact person is contacted successfully, which reduces the contact efficiency between the user and the multi-number contact person. In addition, because the user has attempted other contact manners of the multi-number contact person before the user contacts the multi-number contact person successfully, a trace of failed contacting is left on the terminals corresponding to other contact manners of the multi-number contact person; when the contact person views the trace, the contact person may be misled by the trace and originate an unnecessary contact back to the user, which deteriorates experience of the user and the contact person. In addition, the user may succeed in contacting the contact person only after making multiple attempts, which leads to waste of user time and the operator's operation resources.

### SUMMARY

A technical issue that the present invention intends to solve is to provide a method and a device for contacting a contact person, so as to increase probability of contacting the contact person successfully at a single attempt and save user time and the operator's operation resources.

To solve the above technical issue, the following technical solutions are adopted in the method and device for contacting a contact person in the present invention:

According to a first aspect, the present invention provides a method for contacting a contact person, including:

obtaining a current state of the contact person on a communications platform, where the current state indicates a state of the contact person on the communications platform at current time, and the state is determined according to an operation performed by the contact person on the communications platform or a terminal bound to the communications platform;

determining a contact manner of the contact person, where the contact manner corresponds to the obtained current state; and

setting the determined contact manner as a preferred contact manner of the contact person.

In a first possible implementation manner of the first aspect of the present invention, after setting the determined contact manner as a preferred contact manner of the contact person, the method further includes:

receiving a contact instruction, where the contact instruction is used as an instruction of contacting the contact person; and

presenting a contact manner list that includes multiple contact manners of the contact person, where the multiple contact manners include the set preferred contact manner, and the set preferred contact manner is presented first in the contact manner list.

In a second possible implementation manner of the first aspect of the present invention, the presenting a contact manner list that includes multiple contact manners of the contact person specifically includes: presenting the set preferred contact manner in a first place in the contact manner list; or

presenting the set preferred contact manner in first brightness in the contact manner list, and presenting other contact manners in the contact manner list except the set preferred contact manner in second brightness in the contact manner list, where the first brightness is greater than the second brightness; or

presenting the set preferred contact manner in first chrominance in the contact manner list, and presenting other contact manners in the contact manner list except the set preferred contact manner in second chrominance in the contact manner list, where the first chrominance and the second chrominance are preset.

In a third possible implementation manner of the first aspect of the present invention, after presenting the set preferred contact manner of the contact person to the user, the method further includes:

receiving a contact manner selection instruction, where the contact manner selection instruction is used as an instruction of selecting a contact manner from the contact manner list; and

using the selected contact manner to contact the contact person.

In a fourth possible implementation manner of the first aspect of the present invention, after setting the preferred contact manner of the contact person according to the determined contact manner, the method further includes:

receiving a contact instruction, where the contact instruction is used as an instruction of contacting the contact person; and

using the set preferred contact manner to contact the contact person automatically according to the contact instruction.

In a fifth possible implementation manner of the first aspect of the present invention, the determining a contact manner of the contact person, where the contact manner corresponds to the obtained current state includes:

searching an address book to obtain the contact manner of the contact person, where the contact manner corresponds to the obtained current state, and

the address book is used to store names of contact persons, multiple states of a contact person, and a contact manner corresponding to each state of the contact person.

In a sixth possible implementation manner of the first aspect of the present invention, the communications platform is an application used by the contact person for implementing communication, such as an instant messaging tool, an email, a microblog, a social network, or a text communications tool.

In a seventh possible implementation manner of the first aspect of the present invention, the contact manners include a fixed telephone number or a mobile telephone number.

In an eighth possible implementation manner of the first aspect of the present invention, the contact manners include a telephone contact manner or a network communications contact manner.

In the technical solution of the present invention, a method for contacting a contact person is provided. In the method, a preferred contact manner is determined according to a current state of the contact person on a communications platform, and is provided to a user. Because the preferred contact manner is related with the current state of the contact person on the communications platform, when the preferred contact manner is used to contact the contact person, the success rate of the user contacting the contact person successfully at a single attempt is improved, user time is saved, and user experience is improved. In addition, because the user succeeds in contacting the contact person at a single attempt, the operator's operation resources are saved.

According to a second aspect, the present invention provides a device for contacting a contact person, including:

an obtaining module, configured to obtain a current state of the contact person on a communications platform, where the current state indicates a state of the contact person on the communications platform at current time, and the state is determined according to an operation performed by the contact person on the communications platform or a terminal bound to the communications platform;

a determining module, configured to determine a contact manner of the contact person, where the contact manner corresponds to the obtained current state; and

a setting module, configured to set the determined contact manner as a preferred contact manner of the contact person.

In a first possible implementation manner of the second aspect of the present invention, the device further includes:

a receiving module, configured to receive a contact instruction, where the contact instruction is used as an instruction of contacting the contact person; and

a presenting module, configured to present a contact manner list that includes multiple contact manners of the contact person, where the multiple contact manners include the set preferred contact manner, and the set preferred contact manner is presented first in the contact manner list.

In a second possible implementation manner of the second aspect of the present invention, the presenting module is configured to present the set preferred contact manner in a first place in the contact manner list; or

present the set preferred contact manner in first brightness in the contact manner list, and present other contact manners in the contact manner list except the set preferred contact manner in second brightness in the contact manner list, where the first brightness is greater than the second brightness; or

present the set preferred contact manner in first chrominance in the contact manner list, and present other contact manners in the contact manner list except the set preferred contact manner in second chrominance in the contact manner list, where the first chrominance and the second chrominance are preset.

In a third possible implementation manner of the second aspect of the present invention, the device further includes a contacting module, and the receiving module is further configured to receive a contact manner selection instruction, where the contact manner selection instruction is used as an instruction of selecting a contact manner from the contact manner list; and the contacting module is configured to use the selected contact manner to contact the contact person.

In a fourth possible implementation manner of the second aspect of the present invention, the device includes a contacting module, and the receiving module is further configured to receive a contact instruction, where the contact instruction is used as an instruction of contacting the contact person; and the contacting module is configured to automatically use the set preferred contact manner to contact the contact person according to the contact instruction.

In a fifth possible implementation manner of the second aspect of the present invention, the determining module is specifically configured to:

search an address book to obtain the contact manner of the contact person, where the contact manner corresponds to the obtained current state, and

the address book is used to store names of contact persons, multiple states of a contact person, and a contact manner corresponding to each state of the contact person.

In a sixth possible implementation manner of the second aspect of the present invention, the communications platform is an application used by the contact person for implementing communication, such as an instant messaging tool, an email, a microblog, a social network, or a text communications tool.

In a seventh possible implementation manner of the second aspect of the present invention, the contact manners include a fixed telephone number or a mobile telephone number.

In an eighth possible implementation manner of the second aspect of the present invention, the contact manners include a telephone contact manner or a network communications contact manner.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a first method flowchart of contacting a contact person according to an embodiment of the present invention;

FIG. 2 is a second method flowchart of contacting a contact person according to an embodiment of the present invention;

FIG. 3 is a third method flowchart of contacting a contact person according to an embodiment of the present invention;

FIG. 4 is a fourth method flowchart of contacting a contact person according to an embodiment of the present invention;

FIG. 5 is a schematic structural diagram of a device for contacting a contact person according to an embodiment of the present invention; and

FIG. 6 is a schematic structural diagram of a computer system for contacting a contact person according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

The embodiment of the present invention provides a method for contacting a contact person. As shown in FIG. 1, the method includes the following steps:

Step S101: Obtain a current state of the contact person on a communications platform, where the current state indicates a state of the contact person on the communications platform at current time, and the state is determined according to an operation performed by the contact person on the communications platform or a terminal bound to the communications platform.

Specifically, the current state of the contact person is obtained only when the current state of the contact person on the communications platform changes.

In an implementation scenario of the present invention, the communications platform is an application communications platform used by the contact person for implementing communication, including but without being limited to an instant messaging tool, an email, a microblog, a social network, or a text communications tool. The obtaining a current state of the contact person on a communications platform includes: obtaining the current state according to an operation performed by the user at the current time or in a preset time prior to the current time on the communications platform or a terminal bound to the communications platform.

The current state includes but without being limited to: talking, online, busy, away, offline, at a meeting, and so on. Those skilled in the art can easily design other similar states according to common knowledge. The current state may be generated according to settings made by the contact person, or may be automatically generated by the communications platform according to a preset rule.

The generating, automatically by the communications platform, the current state according to a preset rule may include: if the contact person accesses a conference call or dials a call by using a device on which a communications platform is set, the current state is automatically set by the communications platform to “busy” or “talking”; if the communications platform or the terminal bound to the communications platform receives no input operation of the contact person for a long time, its current state is automatically set to “away”; if the contact person has not logged in to the communications platform of the device, the current state is automatically set to “offline”; if the contact person has logged in to the communications platform of the device and is not dialing a call, is not in a conference call, or does not leave the device idle for a long time, the current state is automatically set to “online”.

It should be noted that, the manners for the communications platform to automatically generate the current state include but are not limited to the above manners, and those skilled in the art can easily design other similar states according to common knowledge.

Step S102: Determine a contact manner of the contact person, where the contact manner corresponds to the obtained current state.

The contact manner of the contact person is determined according to pre-stored or preset information, where the contact manner corresponds to the obtained current state.

Step S103: Set the determined contact manner as a preferred contact manner of the contact person.

Specifically, if the determined contact manner is different from a current preferred contact manner of the contact person, the determined contact manner is set as the preferred contact manner of the contact person; and, if the determined contact manner is the same as the current preferred contact manner of the contact person, the preferred contact manner of the contact person remains unchanged.

After step S103, the determined contact manner becomes the preferred contact manner of the contact person. When the user contacts the contact person by using the communications platform on the device on which the communications platform is set, the communications platform on the device contacts the contact person in the preferred contact manner by default.

Because the preferred contact manner is related with the current state of the contact person on the communications platform, if the user uses the preferred contact manner to contact the contact person, the success rate of the user contacting the contact person successfully at a single attempt is improved, user time is saved, and user experience is improved. In addition, because the user succeeds in contacting the contact person at a single attempt, the operator's operation resources are saved.

In the technical solution in the embodiment of the present invention, a method for contacting a contact person is provided. In the method, a preferred contact manner is determined according to a current state of the contact person on a communications platform, and is provided to a user. Because the preferred contact manner is related with the current state of the contact person on the communications platform, when the preferred contact manner is used to contact the contact person, the success rate of the user contacting the contact person successfully at a single attempt is improved, user time is saved, and user experience is improved. In addition, because the user succeeds in contacting the contact person at a single attempt, the operator's operation resources are saved.

### Embodiment 2

The embodiment of the present invention provides a method for contacting a contact person. As shown in FIG. 1, the method includes the following steps:

Step S101: Obtain a current state of the contact person on a communications platform, where the current state indicates a state of the contact person on the communications platform at current time, and the state is determined according to an operation performed by the contact person on the communications platform or a terminal bound to the communications platform.

Specifically, the current state of the contact person is obtained only when the current state of the contact person on the communications platform changes.

In an implementation scenario of the present invention, the communications platform is an application used by the contact person for implementing communication, including but without being limited to an instant messaging tool, an email, a microblog, a social network, or a text communications tool. The obtaining a current state of the contact person on a communication platform includes: obtaining the current state according to an operation performed by the user on the communications platform in a preset time prior to the current time.

The current state includes but without being limited to: talking, online, busy, away, offline, at a meeting, and so on. Those skilled in the art can design other similar states easily according to common knowledge. The current state may be generated according to settings made by the contact person, or may be automatically generated by the communication platform according to a preset rule.

The generating, automatically by the communications platform, the current state according to a preset rule may include: if the contact person accesses a conference call or dials a call by using a device on which a communications platform is set, the current state is automatically set by the communications platform to “busy” or “talking”; if the communications platform or the terminal bound to the communications platform receives no input operation of the contact person for a long time, its current state is automatically set to “away”; if the contact person has not logged in to the communications platform of the device, the current state is automatically set to “offline”; if the contact person has logged in to the communications platform of the device and is not dialing a call, is not in a conference call, or does not leave the device idle for a long time, the current state is automatically set to “online”.

It should be noted that, the manners for the communications platform to automatically generate the current state include but are not limited to the above manners, and those skilled in the art can design other similar states easily according to common knowledge.

Step S102: Determine a contact manner of the contact person, where the contact manner corresponds to the obtained current state.

The contact manner of the contact person is determined according to a pre-stored or preset correspondence between a contact person state and a contact manner, where the contact manner corresponds to the obtained current state.

It should be noted that the current state includes but without being limited to: talking, online, busy, away, offline, at a meeting, and so on.

Optionally, step S102 may specifically include:

searching an address book to obtain the contact manner of the contact person, where the contact manner corresponds to the obtained current state, and

the address book is used to store names of contact persons, multiple states of a contact person, and a contact manner corresponding to each state of the contact person.

An address book is stored in the device or the communications platform, where the address book stores names of all contact persons, multiple states of a contact person, a contact manner corresponding to each state of the contact person, and so on. For example, correspondences between states of all contact persons and contact manners are stored in the address book in tabular form, and there is also a mapping relationship between a state of a contact person and a contact manner corresponding to each state.

Step S103: Set the determined contact manner as a preferred contact manner of the contact person.

Specifically, if the determined contact manner is different from a current preferred contact manner of the contact person, the determined contact manner is set as the preferred contact manner of the contact person; and, if the determined contact manner is the same as the current preferred contact manner of the contact person, the preferred contact manner of the contact person remains unchanged.

After step S103, the determined contact manner becomes the preferred contact manner of the contact person. When the user contacts the contact person by using the communications platform on the device on which the communications platform is set, the communications platform on the device contacts the contact person in the preferred contact manner by default.

Because the preferred contact manner is related with the current state of the contact person on the communications platform, if the user uses the preferred contact manner to contact the contact person, the success rate of the user contacting the contact person successfully at a single attempt is improved, user time is saved, and user experience is improved. In addition, because the user succeeds in contacting the contact person at a single attempt, the operator's operation resources are saved.

In the technical solution in the embodiment of the present invention, a method for contacting a contact person is provided. In the method, a preferred contact manner is determined according to a current state of the contact person on a communications platform, and is provided to the user. Because the preferred contact manner is related with the current state of the contact person on the communications platform, when the preferred contact manner is used to contact the contact person, the success rate of the user contacting the contact person successfully at a single attempt is improved, user time is saved, and user experience is improved. In addition, because the user succeeds in contacting the contact person at a single attempt, the operator's operation resources are saved.

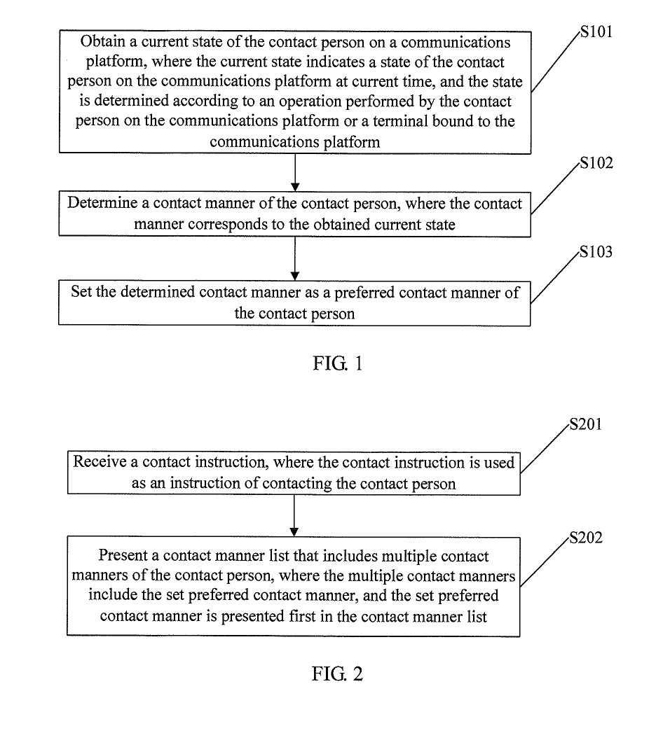

Further, as shown in FIG. 2, after step S103, the method further includes:

Step S201: Receive a contact instruction, where the contact instruction is used as an instruction of contacting the contact person.

The user sends a contact instruction to the communications platform by clicking an avatar or name of the contact person displayed on the communications platform of the device, and the communications platform can obtain the contact instruction from the user, where contact instruction is used as an instruction of contacting the contact person.

Step S202: Present a contact manner list that includes multiple contact manners of the contact person, where the multiple contact manners include the set preferred contact manner, and the set preferred contact manner is presented first in the contact manner list.

After receiving the contact instruction from the user, the communications platform may present a contact manner list that includes multiple contact manners of the contact person to the user. In order for the user to quickly notice the set preferred contact manner of the contact person so that the user can use the set preferred contact manner to contact the contact person, the set preferred contact manner needs to be presented first in the contact manner list.

In an embodiment of the present invention, the presenting a contact manner list that includes multiple contact manners of the contact person specifically includes: presenting the set preferred contact manner in a first place in the contact manner list; or

presenting the set preferred contact manner in first brightness in the contact manner list, and presenting other contact manners in the contact manner list except the set preferred contact manner in second brightness in the contact manner list, where the first brightness is greater than the second brightness; or

presenting the set preferred contact manner in first chrominance in the contact manner list, and presenting other contact manners in the contact manner list except the set preferred contact manner in second chrominance in the contact manner list, where the first chrominance and the second chrominance are preset.

For example, during presenting, the preferred contact manner is in the first place in the multiple contact manners; or, the ground color of the presented preferred contact manner is different from the ground color of other presented contact manners. For example, a yellow ground color is used to present the preferred contact manner, and a white ground color is used to present other contact manners; or the preferred contact manner is enclosed in a certain text box to get distinguished from other contact manners.

Such methods of highlighting the preferred contact manner enhance recognition of the preferred contact manner, so that the user can notice the preferred contact manner at a first glance, which improves user experience.

The embodiment of the present invention does not restrict how to present the preferred contact manner first. Persons skilled in the art may perform settings according to actual conditions, or the user may perform the settings, which further improves user experience.

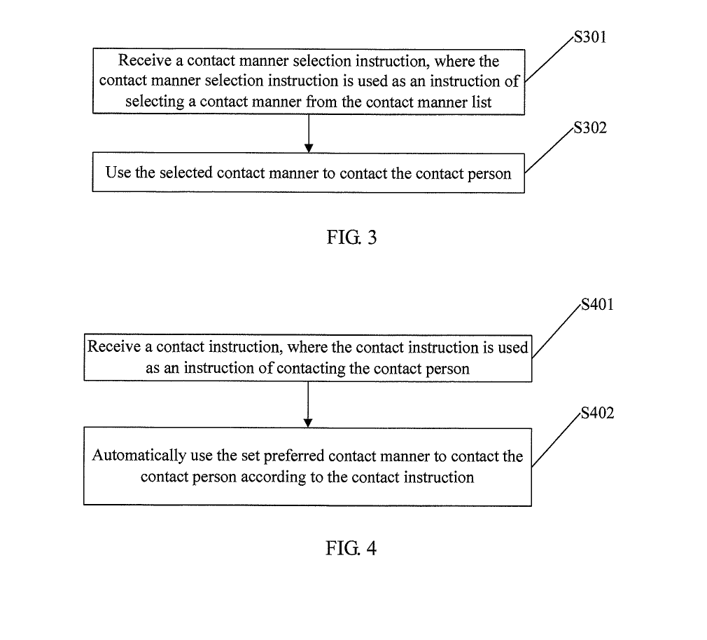

Further, as shown in FIG. 3, after step S202, the method for contacting the contact person further includes the following steps:

Step S301: Receive a contact manner selection instruction, where the contact manner selection instruction is used as an instruction of selecting a contact manner from the contact manner list.

Generally, the contact person has other non-preferred contact manners in addition to the preferred contact manner. When the contact person has other non-preferred contact manners, the communications platform of the device may receive a contact manner selection instruction from the user, where the contact manner selection instruction indicates a contact manner, selected by the user from the contact manner list, used to contact the contact person.

Step S302: Use the selected contact manner to contact the contact person.

The device on which the communications platform is set finally contacts the contact person in the corresponding contact manner according to the contact manner selection instruction of the user.

Different from the method shown in FIG. 2, as shown in FIG. 4, after step S103, the method may further include the following steps:

Step S401: Receive a contact instruction, where the contact instruction is used as an instruction of contacting the contact person.

Step S402: Automatically use the set preferred contact manner to contact the contact person according to the contact instruction.

As described in Embodiment 1, the communications platform of the device generally sets the preferred contact manner of each contact person as a default contact manner of the contact person. When the communications platform of the device receives a contact instruction from the user but receives no contact manner selection instruction, the communications platform of the device may use the preferred contact manner by default to contact the contact person.

In an embodiment of the present invention, the determining a contact manner of the contact person, where the contact manner corresponds to the obtained current state, includes: searching an address book to obtain the contact manner of the contact person, where the contact manner corresponds to the obtained current state, and the address book is used to store names of contact persons, multiple states of a contact person, and a contact manner corresponding to each state of the contact person.

In an embodiment of the present invention, the contact manners include a fixed telephone number or a mobile telephone number. Specifically, if the state of the user is “away” as indicated by an operation performed by the contact person on the communications platform or an office computer terminal bound to the communications platform, and the contact manner corresponding to the “away” state is a mobile telephone number according to a preset or user-defined rule, the preferred contact manner of the contact person is the mobile telephone number. If the state of the user is “online” as indicated by an operation performed by the contact person on the communications platform or an office computer terminal bound to the communications platform, and the contact manner corresponding to the “away” state is an office telephone number according to a preset or user-defined rule, the preferred contact manner of the contact person is the office telephone number.

In an embodiment of the present invention, the contact manners include a telephone contact manner or a network communications contact manner. The network communications contact manner performs communication through a computer network protocol or through a combination of a telecommunications network protocol and a computer network protocol.

Specifically, if the state of the user is “away” as indicated by an operation performed by the contact person on the communications platform or an office computer terminal bound to the communications platform, and the contact manner corresponding to the “away” state is a network communications contact manner according to a preset or user-defined rule, the preferred contact manner of the contact person is the network communications contact manner. The network communications contact manner may be a communications platform that is an application used by the contact person for implementing communication, such as an instant messaging tool, an email, a microblog, a social network, or a text communications tool, or other applications.

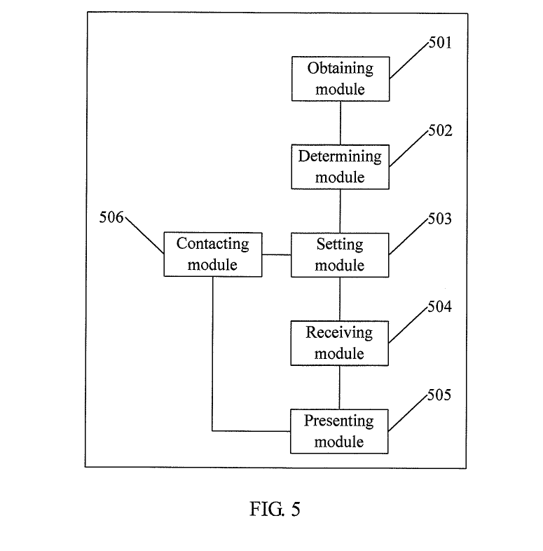

Further, in an embodiment of the present invention, a device for contacting a contact person is provided. As shown in FIG. 5, the device includes:

an obtaining module 501, configured to obtain a current state of the contact person on a communications platform, where the current state indicates a state of the contact person on the communications platform at current time, and the state is determined according to an operation performed by the contact person on the communications platform or a terminal bound to the communications platform;

a determining module 502, configured to determine a contact manner of the contact person, where the contact manner corresponds to the obtained current state; and

a setting module 503, configured to set the determined contact manner as a preferred contact manner of the contact person.

Further, as shown in FIG. 5, the device further includes:

a receiving module 504, configured to receive a contact instruction, where the contact instruction is used as an instruction of contacting the contact person; and

a presenting module 505, configured to present a contact manner list that includes multiple contact manners of the contact person, where the multiple contact manners include the set preferred contact manner, and the set preferred contact manner is presented first in the contact manner list.

In an embodiment of the present invention, the presenting module is configured to present the set preferred contact manner in a first place in the contact manner list; or, present the set preferred contact manner in first brightness in the contact manner list, and present other contact manners in the contact manner list except the set preferred contact manner in second brightness in the contact manner list, where the first brightness is greater than the second brightness; or, present the set preferred contact manner in first chrominance in the contact manner list, and present other contact manners in the contact manner list except the set preferred contact manner in second chrominance in the contact manner list, where the first chrominance and the second chrominance are preset.

Generally, the receiving module 504 may be further configured to receive a contact manner selection instruction, where the contact manner selection instruction is used as an instruction of selecting a contact manner of the desired contact person from the contact manner list.

Further, as shown in FIG. 5, the device further includes:

a contacting module 506, configured to use the selected contact manner to contact the contact person.

The contacting module 506 may be further configured to automatically use the set preferred contact manner to contact the contact person according to the contact instruction.

Further, the determining module 502 is specifically configured to:

search an address book to obtain the contact manner of the contact person, where the contact manner corresponds to the obtained current state, where

the address book is used to store names of contact persons, multiple states of a contact person, and a contact manner corresponding to each state of the contact person.

In an embodiment of the present invention, the communications platform is an application used by the contact person for implementing communication, such as an instant messaging tool, an email, a microblog, a social network, or a text communications tool.

In an embodiment of the present invention, the contact manners include a fixed telephone number or a mobile telephone number.

In another embodiment of the present invention, the contact manners include a telephone contact manner or a network communications contact manner.

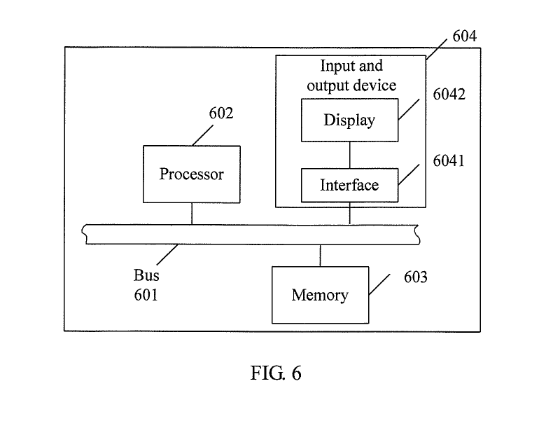

Further, an embodiment of the present invention provides another computer system for contacting a contact person. As shown in FIG. 6, the computer system includes a processor 602, a memory 603, an input and output device 604, and a bus 601. The processor 602, the input and output device 604, and the memory 603 are connected through the bus 601. The memory 603 is configured to store data and code, where the processor 602 is coupled to the memory 603 and calls and executes code in the memory 603 to implement the following functions: obtaining a current state of the contact person on a communications platform, where the current state indicates a state of the contact person on the communications platform at current time, and the state is determined according to an operation performed by the contact person on the communications platform or a terminal bound to the communications platform; determining a contact manner of the contact person, where the contact manner corresponds to the obtained current state; and setting the determined contact manner as a preferred contact manner of the contact person.

The processor 602 coupled with the memory 603 is further configured to call and execute data and code in the memory 603 to determine a contact manner of the contact person, where the contact manner corresponds to the obtained current state in the following manner: search an address book to obtain the contact manner of the contact person, where the contact manner corresponds to the obtained current state, where the address book is used to store names of contact persons, multiple states of a contact person, and a contact manner corresponding to each state of the contact person.

The input and output device 604 specifically includes a display 6042 and an interface 6041 connected with the bus. In an embodiment of the present invention, after the preferred contact manner of the contact person is set according to the determined contact manner, the processor 602 coupled with the memory 603 is further configured to: receive a contact instruction, where the contact instruction is used as an instruction of contacting the contact person; and through the interface 6041 connected with the bus, control the display 6042 to present a contact manner list that includes multiple contact manners of the contact person, where the multiple contact manners include the set preferred contact manner, and the set preferred contact manner is presented first in the contact manner list.

In an embodiment of the present invention, the processor 602 is configured to: control the display 6042 to present the set preferred contact manner in a first place in the contact manner list; or, present the set preferred contact manner in first brightness in the contact manner list, and present other contact manners in the contact manner list except the set preferred contact manner in second brightness in the contact manner list, where the first brightness is greater than the second brightness; or, present the set preferred contact manner in first chrominance in the contact manner list, and present other contact manners in the contact manner list except the set preferred contact manner in second chrominance in the contact manner list, where the first chrominance and the second chrominance are preset.

Generally, the processor 602 coupled with the memory 603 may be further configured to receive a contact manner selection instruction, where the contact manner selection instruction is used as an instruction of selecting a contact manner of the desired contact person from the contact manner list.

Further, the processor 602 coupled with the memory 603 may further use the selected contact manner to contact the contact person, or, automatically use the set preferred contact manner to contact the contact person according to the contact instruction.

In an embodiment of the present invention, the communications platform is an application used by the contact person for implementing communication, such as an instant messaging tool, an email, a microblog, a social network, or a text communications tool.

In an embodiment of the present invention, the contact manners include a fixed telephone number or a mobile telephone number.

In another embodiment of the present invention, the contact manners include a telephone contact manner or a network communications contact manner.

Through the forgoing description of the embodiments, a person skilled in the art may clearly understand that the embodiments of the present invention may be implemented through software plus necessary universal hardware. Based on such an understanding, the technical solutions of the present invention essentially, or the part contributing to the prior art may be implemented in the form of a software product. The computer software product is stored in a readable storage medium, for example, a floppy disk, hard disk, or optical disc of a computer, and includes several instructions for instructing a computer device (which may be a personal computer, a server, or a network device) to perform the methods described in the embodiments of the present invention.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for contacting a contact person, the method comprising:
obtaining a current state of the contact person on a communications platform, wherein the current state indicates a state of the contact person on the communications platform at current time, and the state is determined according to an operation performed by the contact person on the communications platform or a terminal bound to the communications platform;
determining a contact manner of the contact person, wherein the contact manner corresponds to the obtained current state; and
setting the determined contact manner as a preferred contact manner of the contact person.

2. The method according to claim 1, wherein after setting the determined contact manner as a preferred contact manner of the contact person, the method further comprises:
receiving a contact instruction, wherein the contact instruction is used as an instruction of contacting the contact person; and
presenting a contact manner list that comprises multiple contact manners of the contact person, wherein the multiple contact manners comprise the set preferred contact manner, and the set preferred contact manner is presented first in the contact manner list.

3. The method according to claim 2, wherein presenting a contact manner list that comprises multiple contact manners of the contact person comprises:
presenting the set preferred contact manner in a first place in the contact manner list; or
presenting the set preferred contact manner in first brightness in the contact manner list, and presenting other contact manners in the contact manner list except the set preferred contact manner in second brightness in the contact manner list, wherein the first brightness is greater than the second brightness; or
presenting the set preferred contact manner in first chrominance in the contact manner list, and presenting other contact manners in the contact manner list except the set preferred contact manner in second chrominance in the contact manner list, wherein the first chrominance and the second chrominance are preset.

4. The method according to claim 2, wherein after presenting the set preferred contact manner of the contact person to a user, the method further comprises:
receiving a contact manner selection instruction, wherein the contact manner selection instruction is used as an instruction of selecting a contact manner from the contact manner list; and
using the selected contact manner to contact the contact person.

5. The method according to claim 1, wherein after setting the determined contact manner as a preferred contact manner of the contact person, the method further comprises:
receiving a contact instruction, wherein the contact instruction is used as an instruction of contacting the contact person; and
using the set preferred contact manner to automatically contact the contact person according to the contact instruction.

6. The method according to claim 1, wherein determining a contact manner of the contact person, wherein the contact manner corresponds to the obtained current state, comprises:
searching an address book to obtain the contact manner of the contact person, wherein the contact manner corresponds to the obtained current state, and
the address book is used to store names of contact persons, multiple states of a contact person, and a contact manner corresponding to each state of the contact person.

7. The method according to claim 1, wherein the communications platform is an application used by the contact person for implementing communication, the application comprising: an instant messaging tool, an email, a microblog, a social network, or a text communications tool.

8. The method according to claim 1, wherein the contact manners comprise a fixed telephone number or a mobile telephone number.

9. The method according to claim 1, wherein the contact manners comprise a telephone contact manner or a network communications contact manner.

10. A device for contacting a contact person, the device comprising:
an obtaining module, configured to obtain a current state of the contact person on a communications platform, wherein the current state indicates a state of the contact person on the communications platform at current time, and the state is determined according to an operation performed by the contact person on the communications platform or a terminal bound to the communications platform;
a determining module, configured to determine a contact manner of the contact person, wherein the contact manner corresponds to the obtained current state; and
a setting module, configured to set the determined contact manner as a preferred contact manner of the contact person.

11. The device according to claim 10, further comprising:
a receiving module, configured to receive a contact instruction, wherein the contact instruction is used as an instruction of contacting the contact person; and
a presenting module, configured to present a contact manner list that comprises multiple contact manners of the contact person, wherein the multiple contact manners comprise the set preferred contact manner, and the set preferred contact manner is presented first in the contact manner list.

12. The device according to claim 11, wherein the presenting module is configured to:
present the set preferred contact manner in a first place in the contact manner list; or
present the set preferred contact manner in first brightness in the contact manner list, and present other contact manners in the contact manner list except the set preferred contact manner in second brightness in the contact manner list, wherein the first brightness is greater than the second brightness; or
present the set preferred contact manner in first chrominance in the contact manner list, and present other contact manners in the contact manner list except the set preferred contact manner in second chrominance in the contact manner list, wherein the first chrominance and the second chrominance are preset.

13. The device according to claim 11, wherein the device further comprises a contacting module, and the receiving module is further configured to receive a contact manner selection instruction, wherein the contact manner selection instruction is used as an instruction of selecting a contact manner from the contact manner list; and the contacting module is configured to use the selected contact manner to contact the contact person.

14. The device according to claim 10, wherein the device comprises a contacting module, and the receiving module is further configured to receive a contact instruction, wherein the contact instruction is used as an instruction of contacting the contact person; and the contacting module is configured to automatically use the set preferred contact manner to contact the contact person according to the contact instruction.

15. The device according to claim 10, wherein the determining module is configured to:
search an address book to obtain the contact manner of the contact person, wherein the contact manner corresponds to the obtained current state, and
the address book is used to store names of contact persons, multiple states of a contact person, and a contact manner corresponding to each state of the contact person.

16. The device according to claim 10, wherein the communications platform is an application used by the contact person for implementing communication, the application comprising: an instant messaging tool, an email, a microblog, a social network, or a text communications tool.

17. The device according to claim 10, wherein the contact manners comprise a fixed telephone number or a mobile telephone number.

18. The device according to claim 10, wherein the contact manners comprise a telephone contact manner or a network communications contact manner.
